(19) United States
(12) Patent Application Publication
(10) Pub. No.: US 2022/0400656 A1
(43) Pub. Date: Dec. 22, 2022

(54) Coral Reef Float

(71) Applicant: John Ferguson, Baltimore, MD (US)

(72) Inventor: John Ferguson, Baltimore, MD (US)

(21) Appl. No.: 17/807,049

(22) Filed: Jun. 15, 2022

Related U.S. Application Data
(60) Provisional application No. 63/213,311, filed on Jun. 22, 2021.

(51) Int. Cl. A01K 61/54

(52) U.S. Cl. CPC A01K 61/54

(57) ABSTRACT

A coral reef float utilizes a large, elongated steel and, optimally, balloon shaped structures which can be prefabricated en masse, anchored in place to rest buoyant below the ocean surface, and then used to farm live coral. These large structures using biorock applications have insulated copper cables attached at multiple points every 5-10 feet along the structure for homogenous corrosion resistance and mineral accretion on the surface of the structure. A hollow, balloon shaped structure allows more of this copper wiring to be connected internally, where it can be protected from corrosion. Helical anchors can be used in soft sediments and to handle extreme conditions for tethered floats using easy-to-deploy systems onboard ships. Buoyant artificial reefs will be able to be positioned where other artificial reefs cannot effectively be placed.

### RELATED APPLICATION

This application claims the benefit of provisional application S.N. 63/213,311, filed on Jun. 22, 2021.

### FIELD OF THE INVENTION

The present invention relates to the design and construction of underwater, artificial reefs, and particularly to floating reef structures.

### BACKGROUND OF THE INVENTION

Traditionally, artificial reefs have been conceptualized and built at carefully selected locations with solid foundations with multiple attachment points to prevent sinking into sediment. These reefs are constructed of concrete and steel. Biorock (aka seacrete) is an existing technology for applying a low-voltage current to the steel to protect the reef structure from corrosion, deposit calcium carbonate onto its surfaces, and enhance coral growth rates by 2-6× the natural rate. This is typically done with a solar buoy containing a battery for sustained current as well as a low-maintenance titanium anode. Although there are hundreds of Biorock projects worldwide, their applications are hindered by the need for suitable locations in shallow waters protected from pollutants and climate change, the requirements for organizing a team of trained divers for the installation process, and the limited funding of altruistic groups in the marine economy. Biorock's regenerative mineral accretion technology is well known, as described, e.g. in U.S. Pat. No. 5,543,034. However, its application is well-suited to the present invention.

### SUMMARY OF THE INVENTION

It is thus the object of the present invention to provide an underwater coral reef float which effectively and efficiently promotes and enhances marine life accretion on the reef float.

This and other objects are accomplished by the present invention, a coral reef float utilizing a large, elongated steel and, optimally, balloon shaped structures which can be prefabricated en masse, anchored in place to rest buoyant below the ocean surface, and then used to farm live coral. These large structures using biorock applications have insulated copper cables attached at multiple points every 5-10 feet along the structure for homogenous corrosion resistance and mineral accretion on the surface of the structure. A hollow, balloon shaped structure allows more of this copper wiring to be connected internally, where it can be protected from corrosion. Helical anchors can be used in soft sediments and to handle extreme conditions for tethered floats using easy-to-deploy systems onboard ships. Buoyant artificial reefs will be able to be positioned where other artificial reefs cannot effectively be placed.

The present invention, with its hollow steel structure and internal wiring, is used as a substrate for biorock coral growth in low-density artificial reef installations and other marine applications. The self-healing nature of biorock technology allows these structures to endure in marine environments with limited investment and upkeep so long as there is a continuous low-voltage power source. The hollow volumes of these structures allow them to have increased buoyancies so that they may be installed in soft bottom habitats without sinking into the ocean floor. Neutral and positive buoyancies also allow the structures to be tethered to ocean vessels to be towed as seaworthy accessories. These other applications include fish aggregating devices, floating breakwaters, floating swimming pools, and artificial islands.

### BRIEF DESCRIPTION OF THE DRAWINGS

FIG. 1 shows a coral reef float of the present invention.

FIG. 2 is a sectional view showing the internal electrical connections in the coral reef float of the present invention.

FIG. 3 is a partial sectional view showing the internal connections of the coral reef float of the present invention.

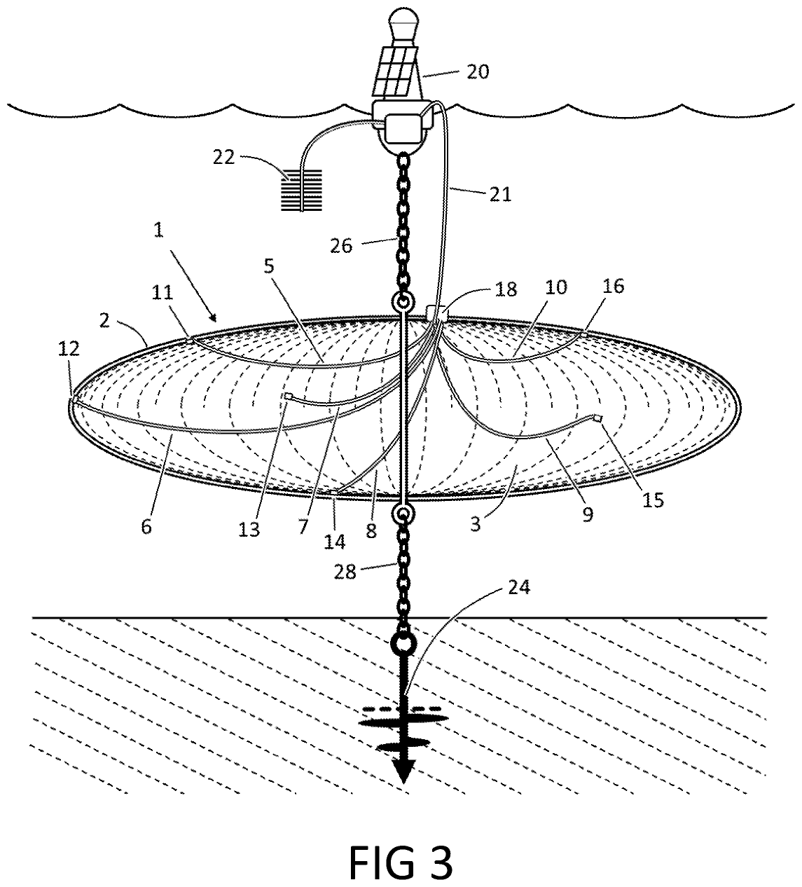

FIG. 4 illustrates growth of marine life on a coral reef float of the present invention.

### DETAILED DESCRIPTION OF THE INVENTION

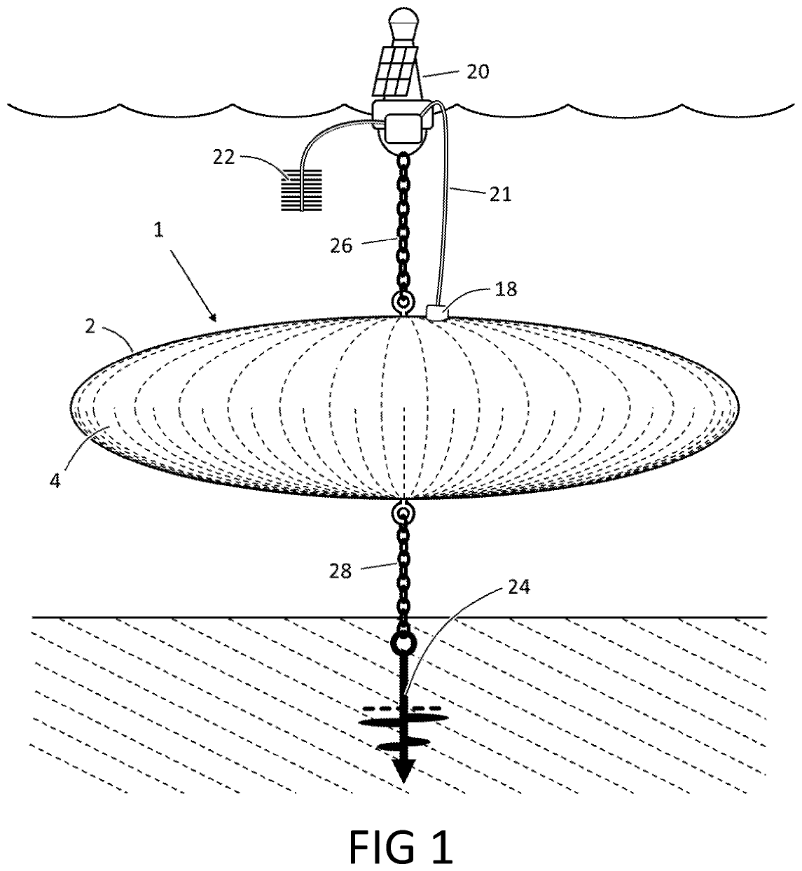

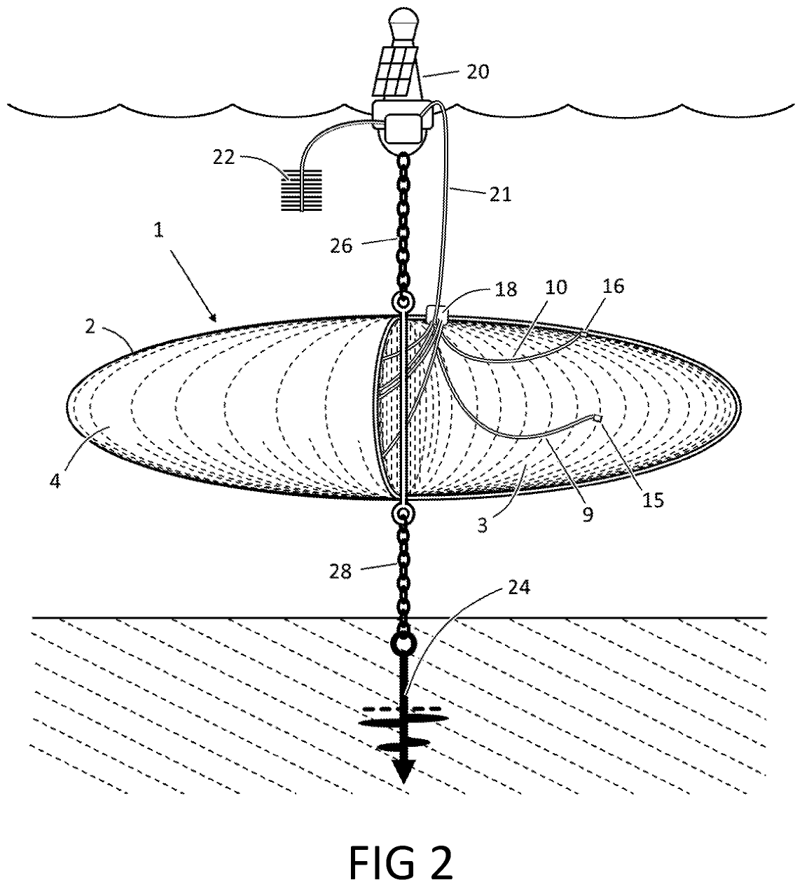

FIG. 1 shows the basic components of coral reef float 1 of the present invention. Reef float 1 comprises elongated, buoyant, hollow elliptical steel structure 2, optimally balloon shaped, although the invention is not be considered restricted to this shape or configuration. Steel structure 2 has inside surface 3 and outside surface 4. As best seen in FIG. 2, insulated copper (or equivalent conductive metal) electric cables, e.g. 5, 6, 7, 8, 9, and 10 are attached at one of their ends directly to electrical contacts 11, 12, 13, 14, 15, and 16 located on inside surface 3 of structure 2. The second ends of the cable are connected to electrical central cable hub 18.

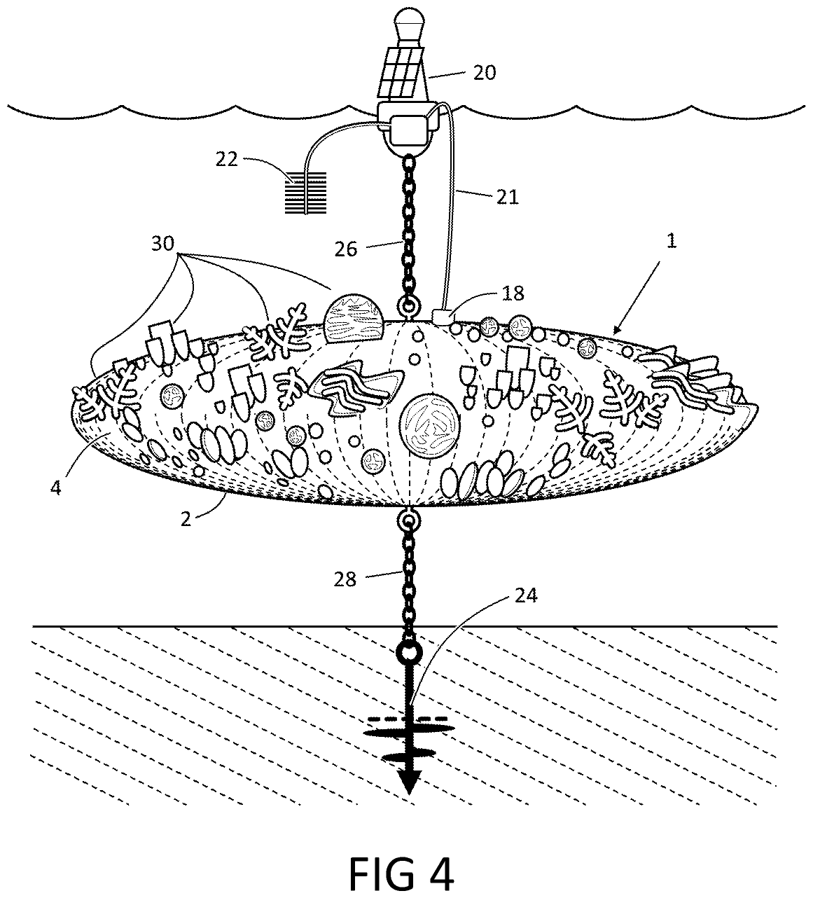

Electrical power source 20, typically a battery or solar buoy, provides electricity to structure 2, main electrical cable 21, via hub 18, through electrical cables 5-10, and then to electrical contacts 11-16, to create the biorock regeneration, mineral accretion of marine life 30 on the structure. See FIG. 4. Power source 20 is shown with underwater anode 22.

Helical or like anchor 24, connected by chains 26 and 28 to structure 2, assists in maintaining the structure in a stationary position below the waterline.

As coral reef float 1 increases in weight/density with accretion, it could be carefully managed to achieve neutral buoyancy upon maturity. Unlike traditional artificial reefs, the coral reef float could then be bought and sold in the aftermarket and relocated. An internal ballast tank could be accessed and connected to a pump on board a tugboat to precisely control the reef float's depth during relocation. Alternatively, short lengths of rebar can be welded at points around the perimeter of the reef float like flower petals so that they may be selectively clipped off to maintain buoyancy.

Coral reef floats can be constructed by welding steel sheet metal onto a steel frame in the desired shape. The multiple electrical contacts inside steel structure 2 are necessary to compensate for voltage drop-off in the steel to ensure the performance of biorock growth, so multiple cables are necessary inside the structure for these connections. Cable hub 18 of the structure can connect to its power source through a single underwater cable 21, as shown, or its power source may be integrated on top, at or above the water's surface. These power sources may include windmills, solar panels, or tidal turbines. Connections from the reef float to a floating power source may require slack to allow for tidal movements.

Filling the reef float structures with inert gas will protect the interior copper wiring from corrosion and ensure they do not require frequent maintenance. The gas is preferably carbon dioxide, but less preferably nitrogen, or argon. The sequestration of carbon dioxide is a desirable and sometimes even profitable feature. Structures may be filled with a weighed quantity of solid carbon dioxide (dry ice) and welded shut before deploying. The minimum final pressure sought inside the structures is dependent on the maximum water pressure at the depths it is predicted to experience. The maximum pressure of carbon dioxide inside these structures is dependent on the integrity of the welded steel sheet metal. Similar welded steel structures in commercial applications store gasses at up to 14 atmospheres of pressure, but higher pressures are possible with thicker steel.

Coral reef floats may be attached to traditional artificial reefs to exploit hybrid properties. Coral reef floats tethered to concrete reef structures may be heavy enough to be anchored to the ocean floor, while being light enough to avoid sinking into the mud. Traditional biorock installations relying on rebar frames may be attached directly to coral reef floats to expand coral growth around the structures' periphery.

Coral reef floats may also act as fish aggregating devices. Their natural coral surfaces provide ecological benefits not found in many other fish aggregating devices. The power draw of their surfaces would optimally require them to have reduced surface area with ellipsoid shapes. A minimum volume constraint from these structures comes from the volume needed to ensure neutral or positive buoyancy. These devices would preferably be wide to maximize the sunlight received from above for coral growth. They would preferably be flat to minimize the area of each side exposed to ocean currents. These devices could be anchored to the bottom by chains that would last for multiple years. Alternatively, devices may have their anchors integrated at the end of anchor shafts composed of steel pipes with internal wiring as needed to maintain biorock growth down to the bottom of the anchor. The buoyancy of these devices requires robust anchor points to secure them in place, so high-performance helical anchors are preferable to alternatives with reduced capabilities.

Floating breakwaters may exhibit elongated structures to optimize their costs as barriers. The structures may interlock with each other to form a chain for extended coverage. Their positive buoyancies would allow them to have surface power sources integrated into their structures, with a central powerline running underwater adjacent to it, connected to each structural link.

Floating swimming pools can offer shallow swimming locations protected from deep ocean currents with a bowl-shaped design. The body of the float acts as the rim in the form of a hollow tube lining the perimeter of a bowl as thick in diameter as necessary to achieve the desired buoyancy.

Artificial islands will have larger volumes to maintain positive buoyancy with significant portions raised above the surface of the water. Artificial islands may be structured after atolls to shelter coastlines from waves in the deeper water. The ring of the atoll surrounding these islands could be at the height of the waves, directly below them, or directly above them. These islands may be terraced to retain natural sediments on their surfaces and the ring of the atoll may be connected by a false ocean floor that would also hold in natural sediments.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A coral reef float for the accretion and propagation of marine life, said coral reef float being positioned beneath the surface of the water and comprising:
an elongated, buoyant, hollow steel structure having an outside surface and an inside surface, said structure being configured to float beneath the surface of the water;
a plurality of electrical cables, each cable having one end connected directly to electrical attachment contacts located on and connected to the inside of the structure, and a second end connected to an electrical cable hub; and
a main electrical cable connected between the hub and an electrical power source; wherein the electrical power source transmits electricity to the structure by means of the electrical attachment contacts to compensate for voltage drop off in said structure, for providing metal corrosion resistance of the structure, and for enhancing marine life propagation and accretion on the surface of the structure.

2. The coral reef float as in claim 1 wherein the structure is balloon shaped.

3. The coral reef float as in claim 1 wherein the structure is filled with inert gas.
